(19) United States
(12) Patent Application Publication
(10) Pub. No.: US 2008/0288594 A1
(43) Pub. Date: Nov. 20, 2008

(54) Electronic Mailing System

(76) Inventor: Thomas Muus, Odense C (DK)

Correspondence Address: STITES & HARBISON PLLC, 1199 NORTH FAIRFAX STREET, SUITE 900, ALEXANDRIA, VA, 22314, US

(21) Appl. No.: 11/720,686

(22) PCT Filed: Dec. 2, 2005
(86) PCT No.: PCT/IB05/54026

§ 371 Date: Aug. 1, 2008

(30) Foreign Application Priority Data
Dec. 3, 2004 (EP) 04028711.2

(51) Int. Cl. G06F 15/16

(52) U.S. Cl. 709/206

(57) ABSTRACT

The present invention relates to a method, a system and corresponding devices for electronic transmission of mail pieces such as post cards front a plurality of local input means (55, 56, 57, 58) at a first geographical location, where an electronic version of for instance a post card can be created to a plurality of local reception and delivery centres or printing facilities (72), where a hard copy of the electronic version of a mail piece is created and subsequently delivered to an addressee. Using a preferred embodiment of the system, a user located at a first geographical location can purchase a post card comprising a picture of a local site of interest and using a user interface post (10) provide this post card with a text message and additional modifications together with the mailing address of an addressee, thereby creating a modified electronic version of the post card. Using the system according to the invention, this electronic version is sent to a reception and delivery centre (72) for instance a local post office or a regional post office (4) receiving mail to be distributed to a number of local post offices. At a local post office in the neighborhood of the addressee a hard copy of the electronic version is created and finally delivered to the addressee. World-wide transmission of the electronic version of a mail piece can for instance be effected via the Internet, although in principle any suitable data transmission network could be used. The system comprises a global portion containing data application means (66), storage means (68) and print server means (69), by means of which global portion for instance data can be shared by the different clients and the electronic version of a mail piece can be routed to the appropriate printing facility (72).

### TECHNICAL FIELD

The invention relates generally to world-wide delivery of mail pieces such as post cards or letters and more specifically to methods, systems and devices for reception or creation of a mail piece at one geographical location and delivery of a replica of this mail piece at the mail address of an addressee.

### BACKGROUND OF THE INVENTION

During resent years the availability of personal computers, both stationary and mobile has become widespread and so has the access to the Internet either from personal computers or from other communication units such as mobile telephones provided with for instance Wireless Applications Protocol (WAP) communication means for access to the Internet, thereby enabling flexible communication on a world-wide basis. Also the use of electronic mail (e-mail) has become available to many users, not only for professional purposes but also for private use. Among other applications of e-mail communication, the use of e-mails for sending for instance holiday greetings to friends and family including text messages and various pictures for instance of the sender with a chosen local background has become popular. By this means of communication the addressee can receive said holiday greetings on his own personal computer.

Although the above mode of communication has become quite popular many people still enjoy receiving an actual post card or letter from a friend abroad due to the more authentic and personal appearance of the received mail piece. Also the sender may not have access to means for sending an e-mail or he may have acquired for instance a special post card, the content and appearance of which he thinks the addressee will particularly enjoy. Thus, the sender would like to provide the addressee with this particular mail piece, possibly provided with a personal text message in the sender's own handwriting and still have the advantage of the rapid and flexible mode of delivery provided by communication via the Internet.

### DISCLOSURE OF THE INVENTION

On the above background it is a first object of the present invention to provide a method and corresponding system and devices allowing a person to purchase a post card or other mail piece at a first geographical location and at a second geographical location recreate a replica of this post card or other mail piece for delivery to the addressee by the postal system at the second geographical location Thus, according to one embodiment, the present invention simulates the actual physical delivery of for instance a post card purchased at one geographic location at a second remote address for instance in another country.

According to other embodiments of the present invention it is possible to alter the appearance of the original physical mail piece for instance by adding various kinds of graphical and/or pictorial elements to the post card prior to sending it from the first geographical location. A number of ways of modifying the appearance and content of the original mail piece will be described in the detailed description of the invention. According to the invention it may even be possible to add sound and/or still or moving pictures to the original post card as will also be described further below.

Optionally the mail piece delivered at the second geographical location may not be based on an actual physical mail piece provided at the first geographical location, such as an actual physical post card comprising a picture and provided with a text message but may alternatively be based on pictures, text and other data provided by the system according to the invention, access to which can be attained at the first geographical location and which information can be used for creating an electronic version of a mail piece. Both traditional 2-dimensional mail pieces such as post cards and letters may be sent to/delivered to an addressee by the method and system according to the invention, but also more sophisticated kinds of “mail pieces” or communication items may be passed between a sender and an addressee using the method and system according to the invention. Among such more sophisticated communication items 3-dimensional images may be mentioned.

Thus, according to a first aspect of the present invention there is provided a method for delivery of mail pieces at an addressee comprising the following steps:
(a) at a first location creating an electronic version of an actually existing physical mail piece or creating a new mail piece;
(b) provision of the address of a reception and delivery centre (for instance a local or regional post office) or printing facility at a second location to which said electronic version of the mail piece is to be sent;
(c) transmission of said electronic version and said address via a transmission path to said reception and delivery centre;
(d) creation of a hard copy of the electronic version of the mail piece at said reception and delivery centre;
(e) delivery of said hard copy from the reception and delivery centre to the addressee, for instance at his mailing address, a pick-up address or at the reception and delivery centre itself.

The above address of the reception and delivery centre/printing facility may comprise only the country and/or postal number (for instance DK 1601 indicating a central postal area of Copenhagen in Denmark), whereas the postal address of the addressee could be contained in the electronic mail piece itself.

Referring to point (e) above, delivery of the hard copy of the mail piece could take place for instance by a special delivery service in stead of the postal service—for instance the local post office—at the site of reception. In such cases it might be necessary to indicate the address of this special service specifically, whereas in case of normal postal delivery the mailing address, for instance comprising the addressee's name, street and street number, postal number or zip code and country, would be sufficient for identifying the proper reception centre for the particular addressee.

Referring to point (c) above, the transmission path could comprise the Internet. As will be described in more detail below, the transmission path could furthermore comprise at least one global centre for providing global facilities which may be shared by all users of a system according to the invention and for control and supervision of the method and system of the invention. Thus, for instance mail pieces generated at one geographical location containing for instance a scenery or other information which could potentially be interesting for senders at other geographical locations could according to the invention be shared between different geographical locations and for instance stored at said global centre. The invention thus provides for the possibility of information interaction between various senders for instance during the creation of the electronic version of a mail piece.

Specifically, although not necessarily, the creation of an electronic version of a mail piece can according to the invention be based on an actual physical mail piece, as for instance a post card purchased at the first geographical location but it can also be based on libraries of pictures or other lay-outs of mail pieces stored in the system implementing the above method and available to the user at the site of creation of said electronic version of a mail piece. In the first of the above cases a step of actually providing a physical mail piece would precede step (a) above.

A mail piece can be any type of entity, which could be delivered by mail. A post card would be a typical example of a mail piece, which could be delivered by means of the method, system and devices according to the present invention. The electronic version of the post card would in this context comprise an electronic version of the post card itself provided with a text message written by the sender and the mailing address of the addressee. The post card can either be provided with a physical stamp prior to the creation of the electronic version or as an option an electronic “stamp” or code replacing a stamp (for instance the PP-mark in Denmark) can be created along with the creation of the electronic version of the post card. Such alternatives will be described in more detail in the detailed description of the invention.

According to the inventive method, the address of the reception and delivery centre can either be chosen by the sender himself or optionally be automatically chosen by the system carrying out the inventive method based on the mailing address of the addressee provided by the sender.

According to a second aspect of the present invention there is provided a system for delivery of mail pieces to an addressee comprising:
(a) means (for instance a user interface post or stand, which will be described in detail in the following) for creating an electronic version of a mail piece comprising means for providing information about the appearance (pictures, text fields etc.) of a mail piece and means for loading at least one of the mailing address of an addressee, the address of a reception and delivery centre, or an address where said addressee can pick up a hard copy of the electronic version of a mail piece, into the system;
(b) means for transmission of said electronic version and said addresses to a transmission network;
(c) means for downloading of said electronic version from said transmission network and provision hereof to one or more reception and delivery centres; and
(d) means for providing a hard copy of the electronic version of the mail piece at at least one of said reception and delivery centres for subsequent delivery to or pick up by the addressee.

According to one embodiment, the system furthermore comprises at least one global centre for instance for providing common facilities to all of said user interface posts or other input means used by a sender of an electronic mail piece such as pictures for inclusion in electronic versions of mail pieces etc and for control and supervision of the data transmission throughout the system. Thus, according to this preferred embodiment of the invention, the system comprises:
(a) means for creating an electronic version of a mail piece comprising means for providing information about the appearance (pictures, text fields etc.) of a mail piece and means for loading at least one of the mailing address of an addressee, the address of a reception and delivery centre or an address where said addressee can pick up a hard copy of the electronic version of a mail into the system;
(b) means for transmission of said electronic version and said addresses to a global control and supervision system;
(b) means for downloading of said electronic version from said global control and supervision system and provision hereof to a reception and delivery centre; and
(c) means for providing a hard copy of the electronic version of the mail piece at said reception and delivery centre for subsequent delivery to or pick up by the addressee.

According to a specific embodiment of the invention there is provided a system for producing hard copies of electronic mail pieces at a reception and delivery centre or printing facility for subsequent delivery to an addressee of pick up by the addressee. The system—which will be described in more detail in the detailed description of the invention—comprises:
(a) one or more clients for creating an electronic version of an actually existing physical mail piece or for creating a new mail piece;
(b) interface applications for communication with said clients;
(c) one or more server applications communicating with said interface applications;
(d) one or more print servers for providing data files representing said electronic mail pieces to a chosen one or more of said reception and delivery centres/printing facilities and managing and controlling printing operations etc. at these centres/facilities;
(e) one or more global storage means/databases communicating with said server applications and said print server(s).

The print servers ensure among other things that the electronic data forwarded to each individual printing facility are of a form accepted by the particular printing facility, for example relating to the properties of the electronic files making up the electronic mail piece. Thus, different printing facilities may require different data formats and file properties according to the specific types of printers, etc. at these facilities.

According to the invention, the above-mentioned clients could be mobile phones, stands or user interface posts, kiosks or personal computers or other electronic communication means, which may either be stationary or mobile.

According to an embodiment of the invention, the system comprises a payment server for management and control of payment for transactions carried out by means of the system.

According to the invention, the above-mentioned storage means/database can be used for storing electronic representations of images, texts, etc. which may be used by all clients of the system for the creation of the finished electronic version of a mail piece. As mentioned previously, different clients may even share information, pictures etc. and interact with each other through the global server application and associated storage means of the system according to the invention. Furthermore, a global back-up copy of a mail piece may be stored.

Furthermore, the storage means/database may be used for temporarily storing electronic versions of mail pieces prior to their provision from said print server to said reception and delivery centres/printing facilities.

According to the invention, the whole application necessary for the creation of said electronic version of a mail piece can be run on the above-mentioned server application, i.e. globally. It may, however, alternatively be run either on a specific client, provided this client possesses enough processing/storage capacity to run the complete application, or the application may be shared between the server application of the system according to the invention and a given client. By running either the complete necessary application or part of this on specific clients, the global functional entities of the system can be relieved of work.

Further details of the preferred embodiment of the system according to the invention will be found in the detailed description of the invention.

Furthermore, the present invention relates to an electronic kiosk or user interface post or stand, i.e. an interface means for creating an electronic version of said mail piece as well as a receiving station for receiving an electronic version of a mail piece and creating a hard copy of this electronic version. As used in the present context, the term “user interface post or stand” is used to indicate a single physical unit at which the user can create or manipulate electronic versions of for instance post cards. The interface means may among other features comprise means for scanning of the mail piece, means for displaying the scanned version of the mail piece, means for providing a hard copy of the scanned and finished mail piece, means for providing the scanned mail piece with text and means for payment for the transaction. Numerous other features may optionally be present in the means and some of these will be described in the detailed description of the invention. The term “kiosk” is in the present context used to indicate a region, for instance a booth, enclosure or dedicated room containing said user interface post but possibly also containing other physical units which can be used during the creation or manipulation of electronic post cards or other mail pieces. Such units could for instance comprise a camera for taking a picture of the user for inclusion on the electronic version of the post card and this camera may advantageously be placed remotely from said user interface post. The kiosk may furthermore comprise a table for initial preparation of a mail piece prior to provision hereof the user interface post.

In a broader sense, the term “kiosk” may also relate to any portable electronic communication unit comprising means for creation and manipulation of an electronic mail piece. As an example of a communication unit, a mobile telephone provided with a camera could also be regarded as a “kiosk” within the context of the present invention.

In the first mentioned case where a kiosk is a region containing a user interface post according to the invention, the kiosk may be provided with a number of such user interface posts. Additionally tables for preparation of post cards could also contain some of the features (described in the detailed description of the invention) of the user interface post so that a part of the preparation of the electronic version of the mail piece can take place from the table rather than from the interface post. In this case the table should be provided with means for communicating with the interface post.

A number of embodiments of the above method, system and devices are described in the detailed description of the invention and defined by the corresponding dependent claims.

Application of the method, system and devices according to the invention as defined above can be exemplified by the following series of events, but it is understood that this is only one specific example of an application of the method, system and devices according to the invention. Further details will appear from the detailed description of embodiments of the invention.

A person attending an international convention has during the interval between successive presentations of papers at the convention centre found time to visit the picturesque old castle of the town in which the convention takes place and has in fact been able to purchase a post card of the castle. He wants to send this post card provided with a greeting to a friend living abroad. He knows that his friend is particularly fond of getting personal greetings, in the senders own handwriting, from travelling friends and in fact he values the authenticity of the received post card including the proper stamp of the country from which the post card is sent provided with the proper postmark. Time is short, however, and the sender has no time for visiting a post office to get a stamp and he is at any rate leaving the country of the convention in a few hours. It would be out of the question to take the post card with him on leaving the country and post it at a later opportunity.

The convention centre is, however, provided with a post or kiosk according to the present invention where the post card can be scanned (and provided with pictures etc.) either provided with the text in the senders own handwriting prior to the scanning process or optionally provided with means for handwriting on the scanned image of the original post card. As mentioned previously, not only traditional 2-dimensional post items but also more sophisticated items comprising 3-dimensional images and/or post items, video sequences and audio sequences may according to the invention be generated at the post/kiosk. The post furthermore provides for the possibility of establishing the image of the post card with a picture of a stamp from the country where the user interface post is situated and means for writing the mailing address of the addressee on the image in case the sender has not already written the mailing address on the original post card. Optionally the sender is also able to provide the post with information relating to the nearest post office for delivery of the post card in the country of the addressee for the purpose of ensuring that the post card be delivered to the addressee as soon as possible. Thus, the actual sending of the original, authentic post card requires very limited time and can easily be carried out at the convention centre. The sending of the post card can furthermore be charged on the post by a number of means for instance either by payment by cash or by means of the sender's credit card or other electronic payment means. Soon the next day the addressee receives his mail piece, the appearance of which can resemble an original post card or other mail piece very closely.

The present invention offers a number of advantages for a user wishing to communicate world-wide with an addressee in cases where the addressee desires to receive a mail piece, i.e. physical entity corresponding to what he would have received in case of actual world-wide postal delivery.

### BRIEF DESCRIPTION OF THE DRAWINGS

The invention will be more fully understood by reference to the following detailed description of the invention in conjunction with the drawings, where:

FIG. 1 shows a schematic overview of a system according to the invention;

FIG. 2 shows a schematic perspective view of one embodiment of an interface post designed as a desk;

FIG. 3 shows a schematic representation of a layout of an image of a post card;

FIG. 4 shows a schematic representation of an alternative post card;

FIG. 5 shows a schematic block diagram of an embodiment of an interface post and external server according to the invention;

FIG. 6 shows a schematic representation of the system and associated equipment at the receiving side of the Internet;

FIG. 7 shows a schematic overall representation of an embodiment of the system according to the invention comprising four different digital input means;

FIG. 8 shows more detailed the client applications with associated interface application, server application and print application:

FIG. 9 shows more detailed interface applications and associated server applications;

FIG. 10 shows more detailed the print server;

FIG. 11 shows more detailed the print delivery service; and

FIG. 12 shows a wizard for use by creation of electronic postcards from mobile phones.

### DETAILED DESCRIPTION OF THE INVENTION

In the following detailed description of the present invention, embodiments of the system and associated devices according to the invention are shown and described in detail but it is understood that other embodiments of the underlying concept of the invention are also possible and comprised within the scope of the present invention as defined by the accompanying claims.

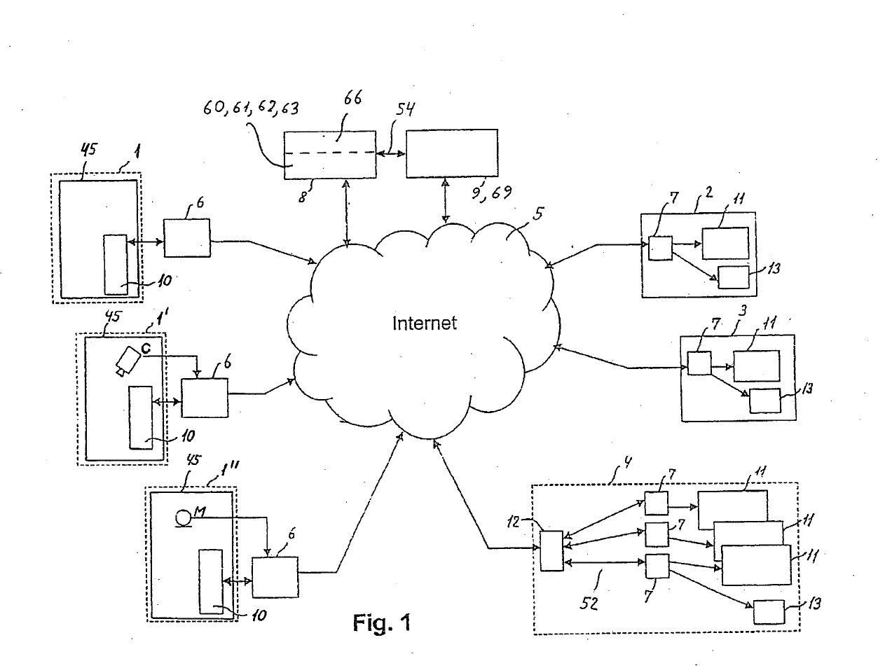

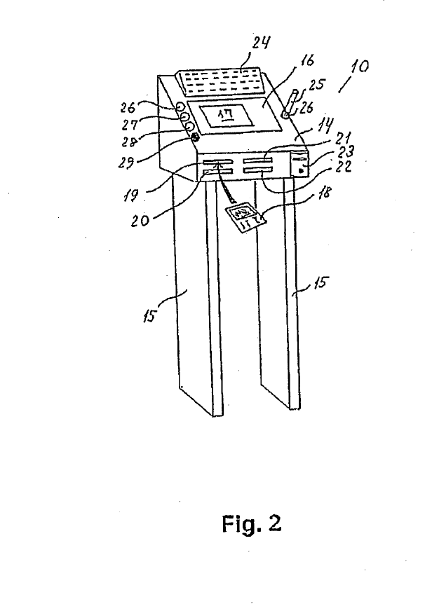

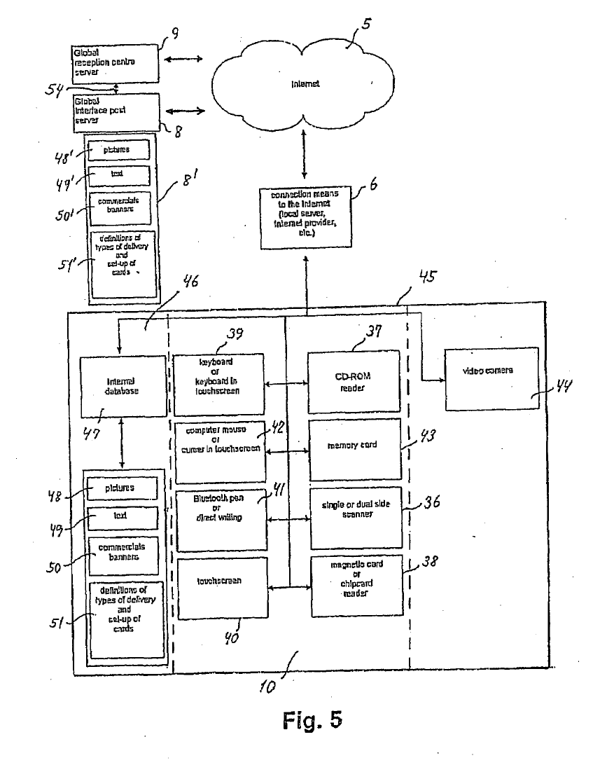

Referring to FIG. 1 there is shown a schematic overview of a system according to the invention. At one or more first geographical locations 1, 1′, 1″, where one could for instance be a hotel, convention centre or a place of historical interest there is provided a kiosk 45 comprising one or more user interface posts 10 and possibly also various additional equipment which will be described in the following for creating an electronic version of a mail piece for instance a post card. Among other features the interface post may comprise scanning means for scanning an actual physical mail piece for subsequent creation of a finished electronic version hereof. An embodiment of the user interface post 10 will be described in detail below in connection with FIGS. 2 and 5. In addition to the user interface post 10 other means for recording information to be incorporated in the electronic version of the mail piece may be provided, either in the interface post itself or adjacent the interface post for instance in a kiosk or booth in which the interface post is situated. Such means could consist of a video camera C, camera and/or a microphone M as shown in FIG. 1. The created electronic version of the mail piece is transmitted to the Internet (or other suitable communication network) indicated by reference numeral 5. Thus, the post 10 can be connected to a chosen Internet provider as symbolized purely schematically by the block 6 in FIG. 1. A more detailed description of an embodiment of this transmission is given in connection with FIG. 5 and FIGS. 7 through 11. Via the Internet 5 access can be obtained to receiving locations 2, 3 and 4 for instance located in other countries around the world. The specific geographical location to which the electronic version of the mail piece is to be sent can be chosen by the sender at the interface post 10 by various means as described below.

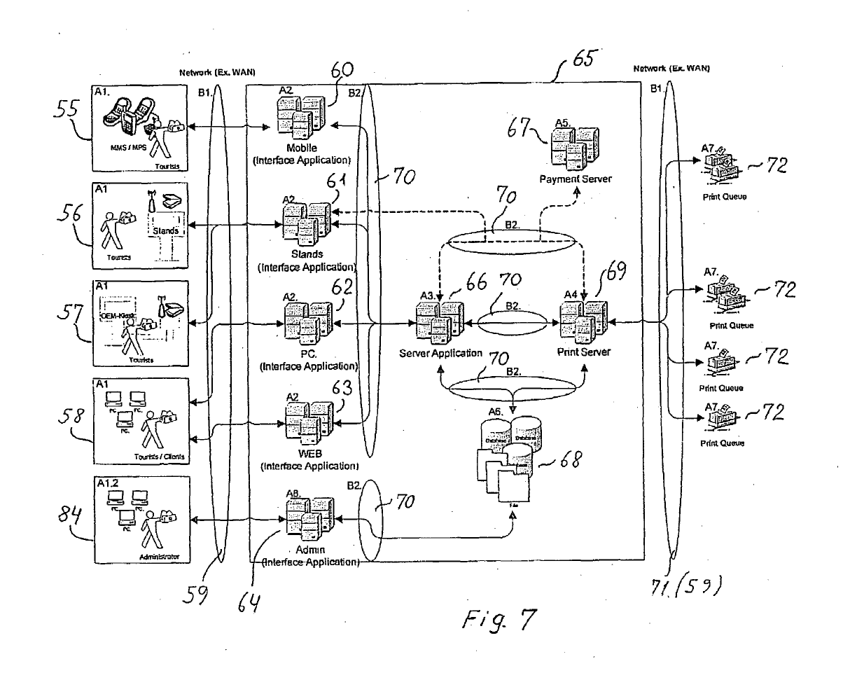

According to a preferred embodiment of the invention, the system is provided with a global system (indicated schematically by reference numerals 8 and 9 in FIG. 1 and by 65 in FIGS. 5 and 7 comprising for instance a global database 8′, 68 for storing information that can be shared by all users (user interface posts 10 or clients 55, 56, 57 and 58 in FIG. 7) of the system. Furthermore, it will be beneficial if the system is provided with a global control and supervision system 9 for controlling transmission of data throughout the system. Although in principle each of the user interface posts 10 could communicate via a suitable network such as the Internet 5 directly with each of the local reception and delivery centres 2, 3, 4 it is advantageous that each reception and delivery centre communicates with a single global centre (a single address in the transmission network) and that similarly each user interface post communicates with a single global interface server containing said global database. The global centres 8, 9 may be situated in the same facility, for instance a chosen hotel or convention centre or at a chosen Internet provider and may communicate directly with each other as shown by the double arrow 54 although they may also in principle be situated at different geographical locations and for instance communicate with each other via the Internet 5. A transmission path from a given user interface post to a given chosen reception and delivery centre/printing facility could thus be: User interface post 10—Internet 5—global interface post server 8—global control and supervision centre 9—Internet 5—local reception and delivery centre 2, 3, 4.

It is understood that the subdivision of the global portions of the system according to the invention into two centres, i.e. the global interface post server 8 and the global control and supervision centre 9 is not in principle necessary for the functioning of the system according to the invention. A specific embodiment of the system according to the invention, showing among other things more details of the global portion of the system will be described in connection with FIGS. 7 through 12.

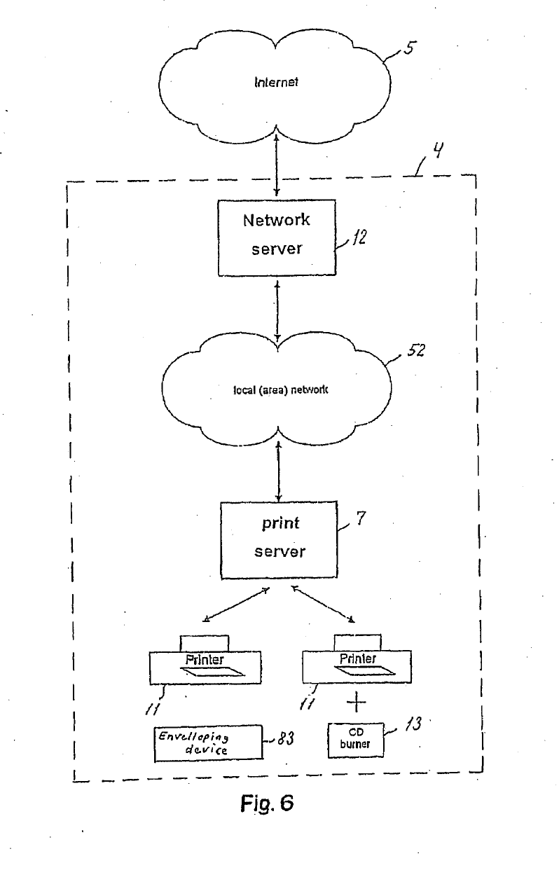

A “second geographical location” can for instance be region (for instance a country or a specific region within a country or a large city etc.) as indicated schematically by reference numeral 4 comprising a regional post office serving as a central reception and distribution centre, and provided with means such as a network server indicated schematically by 12 for communicating with the Internet 5 and furthermore via a local network with a number of local post offices indicated by 7, 11 in FIG. 1. Each of these may comprise a print server 7 and an appropriately designed printer 11 for providing the hard copy of the electronic version of the mail piece. These printers can be adapted for creation of a hard copy closely resembling the original mail piece. Thus in the case of an actual physical post card based on which an electronic version is generated either at the interface post 10 or through co-operation between the interface post 10 or other clients of the system and the global system 8, 9, 65 the appearance of the hard copy provided by the printing means 11 can if desired be brought to closely resemble the original post card. The printed hard copy can afterwards be provided to the mailing address of the addressee by the ordinary mailing service of the region in which the post office is situated. The addressee thus receives a post-card, the appearance of which corresponds to the original post card including hand written text and address of the addressee as written on the original post card by the sender. The second geographical location as indicated by 4 could also be a post office provided with a large number of printers for example for printing different types of mail pieces, each of these printers 11 being controlled by a print server 7 and connected to the network server 12 of the post office via a local area network (LAN) 52 (FIG. 6). Furthermore, the second geographical location could be a single post office as schematically indicated by 2 and 3 in FIG. 1 provided with appropriate network—and print servers and at least one printer. At least some of the post offices may furthermore be provided with means for storing information contained in the electronic version of the mail piece, for instance pictures, video- and audio sequences. Such means may consist of a CD- or DVD burner or means for writing on a memory card schematically indicated by 13 in FIG. 1 but other storage media may of course also be applied.

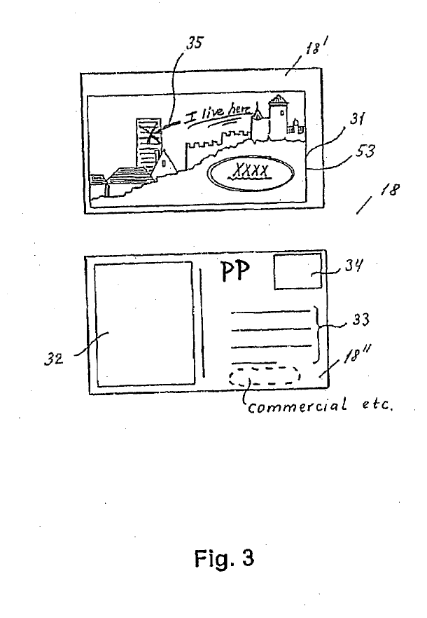

Now referring to FIG. 2 there is shown an exemplary embodiment of a user interface post or stand 10 for use in the method and system according to the present invention, but it is understood that numerous other embodiments would also be possible. The interface post shown in FIG. 2 is designed in the form of a desk 14 supported by a couple of stands 15. The upper, inclined surface of the desk is provided with a display screen 16, which could be a touch screen upon which a picture of the post card or other mail piece 17 can be displayed. The interface post shown in FIG. 2 is furthermore provided with means for scanning a post card 18 schematically indicated at 19 (or alternatively for providing a picture of the post card by means of a camera etc.) and writing mean s indicated at 20 which could among other things be used for the provision of a hard copy of the finished electronic version of the post card. Also reader means 21, 22 for reading data stored on a medium such as a CD or memory card can be provided on the interface post. Furthermore, payment means, schematically shown as a credit card reader 23, by means of which payment for the transaction can take place can be provided. In stead of means for payment by credit card, the interface post 10 may also comprise a coin-operated machine for paying by cash or other means for affecting electronic payment of transactions. Another means of payment according to the invention will be described in connection with FIG. 3 below. Still other payment modes may be contemplated by a person skilled in the art and would fall within the scope of the invention as defined by the independent claims. Scanning can be performed by dual scanning means scanning both sides of the post card 18 simultaneously or by a single scanning means scanning one side at a time. In stead of a scanner, a suitable digital camera may as mentioned above be used to provide the image of the post card 18 to be used in the creation of the electronic version of the mail piece. In either instance either one or both images of either sides can be shown on the screen 16 for further processing of the electronic version of the post card.

Various means for providing the scanned post card with text can be provided. In the embodiment shown in FIG. 2 such writing can be performed by means of the keyboard 24, which could for instance be used for entering the mailing address of the addressee or information to the system relating to location of the post office closest to the addressee. As a very desirable feature, the interface post may furthermore be provided with means for handwriting on the image 17 of the post card in cases where the original physical post card 18 has not already been provided with hand written text prior to scanning of the post card. Such writing on the image of the post card could for instance be accomplished by means of a Bluetooth pen 25 housed in a holder 26 when not used and preferably secured to the interface post by appropriate means in order to prevent removal of the pen from the interface post. Optionally the user might also use his own Bluetooth pen. A number of dedicated function keys 26, 27, 28 and 29 may also be provided for instance for initiating scanning of a post card, writing of a hard copy hereof and choosing between images of either the front side, rear side or both of the sides of the post card. One function key 29 could be used for initiating the transmission of the electronic version of the post card for instance to a local server and via an internet provider to the Internet.

Using the reader indicated by 21 or 22 on FIG. 2 it may furthermore be possible to provide the created electronic version of a mail piece with the address information of a particular addressee and the user may for instance use a suitable recording medium such as a CD-ROM for storage of a complete list of addresses for loading into the interface post as required. Furthermore, as an option this stored address list may also comprise addresses of the post offices or other local reception and delivery centres located close to the mailing address of the addressee. Postal addresses may also be downloaded from the Internet and the user interface post 10 provided with means for reading such information.

Although not shown in FIG. 2, either the interface post itself or the kiosk in which it is situated can be provided with a camera and/or microphone for recording to pictures, video and sound to be delivered to the addressee together with the mail piece. Also means for creating 3-dimensional representations of objects may be incorporated at the user interface post or kiosk.

Apart from creating an electronic post card from a scanned version of an actual physical post card, the interface post (or an associated server etc.) may also be provided with a library of pictures for use during the creation of the electronic version of a post card. Furthermore, pre-recorded pictures and/or text may be loaded into the interface means as indicated at 21 or 22 of FIG. 2 or transferred wireless (for instance by a Bluetooth transmitter or IR transmitter) from a suitable data storage means to the user interface post. It is also possible to provide either the interface post itself or a kiosk in which it is situated with video camera for instance for taking a picture of the sender for inclusion in the post card. Even sound or moving pictures may be included in the electronic version of the post card and on reception at one of the post offices indicated on FIG. 1 be stored on a suitable medium such as a CD, DVD or memory card for delivery to the addressee together with the post card. As an option, the storage medium could be placed in a folder or catalogue of the receiving centre (as for instance a folder designed as a special Christmas greeting) and delivered to the addressee.

Now referring to FIG. 3 there is shown a schematic representation of a layout of an image of a post card scanned into the interface post. In the upper part of FIG. 3 there is shown the front or picture side 18′ of the post card 18 comprising the picture field 31. Below is shown the rear or text side 18″ of the post card 18 comprising a text field 32, an address field 33 and a stamp field 34. As an option the text field 32 may extend over the complete text side 18″ of the post card, possibly with the stamp field left free. In the stamp field 34 may be inserted an electronic version of a stamp from the geographical area in which the user interface post/kiosk is provided. This electronic stamp can be transmitted through the system to the reception and delivery centre and printed on the hard copy at this location. Also payment for the transmission/delivery of the mail piece to the addressee may be effected by special postmarks (for instance PP-mark in Denmark).

In the interface post, cursor means (for instance a computer mouse or optionally a touch on the touch screen in case the display screen 16 is actually of this type) can be provided for indicating the various lines of the address field. Thus, in case of using the keyboard 24 for entering text to the address field 33, the sender may point to the uppermost line of the address field and then enter the name of the addressee. On the other lines of the address field, the street name and number, the zip code and the country of the addressee can be entered using the keyboard.

Using the Bluetooth pen 26 shown in FIG. 2, the user may furthermore provide the picture shown on the front side 18′ of the post card with text or drawings as indicated in FIG. 3, where the user (reference numeral 35) has indicated the site of his room in a hotel building on the location.

Furthermore, the interface post or the local server can be provided with commercials, for instance the logo or trademark of a travelling agency or a local sponsor for inclusion in the post card. This option is indicated in FIG. 3 by reference numeral 53.

A mode of payment for the transmission of the electronic version of a post card which is an alternative to those described previously consists of applying a label comprising a PDF-417 bar code to the stamp field 34 or elsewhere on the post card. The user interface post must be provided with means for reading the bar code, for instance a suitable laser scanner and corresponding decoding software. When the information contained in the bar code has been read, the image of the bar code is removed prior to transmission of the electronic version of the mail piece and it can if desired be replaced by an image of for instance a stamp from the geographical location (country) of the user interface post.

Alternatively, payment may by effected by application of a PP-mark or similar on the mail piece as mentioned above.

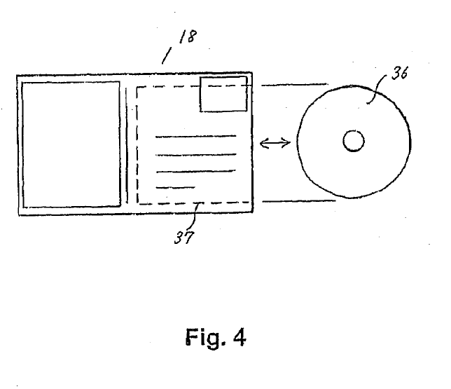

Occasionally an actual physical post card or other mail piece can be provided with a storage medium, for instance a CD, DVD or memory card for delivery together with the mail piece. This is indicated schematically in FIG. 4 by a CD, DVD or memory card 36, which can be accommodated in a pocket 37 in a post card. The storage medium can contain for instance audio data (a spoken greeting from the sender etc.), still images or even video sequences for instance recorded by the sender during his holiday or participation at an international convention.

Now referring to FIG. 5 there is shown a schematic representation of an embodiment of those portions of the system according to the present invention preceding the reception centres 2, 3, 4 shown in FIG. 1.

It is envisaged that the system according to the present invention in its broadest set-up comprises a large number of user interface posts/kiosks or other input means such as mobile phones as shown in FIG. 7 located all over the world. All of these interface posts/kiosks etc. communicate via the Internet (or other suitable communication networks) with a large number of reception and delivery centres or printing facilities at receiving locations as already mentioned in connection with FIG. 1. World-wide supervision and control of data transfer between the various interface posts and reception centres can be performed by global centres, for instance the global interface post server 8 and the global control and supervision centre 9 mentioned in connection with FIG. 1. It is also possible to provide general access to libraries of pictures, commercials etc. stored on a global database indicated by 8′ in FIG. 5. Thus, all interface posts within the system may share certain functions, pictures and text pieces apart from those functions, pictures, text pieces and additional features that are provided at the individual interface posts. This may reduce the costs and hardware requirements of the overall system according to the invention and facilitate updating of the information to be shared by all user interface posts throughout the system. Similarly, the provision of a global system for control and supervision, for storage of information which can be shared by all clients using the system, for temporarily storing finished electronic versions of mail items and for controlling/setting data communication parameters required by the individual reception and delivery centres or printing facilities is advantageous compared with a system where each user interface post should communicate directly with each reception and delivery centre, this requiring a lot of unnecessary duplication of control and management applications at the individual user interface posts or clients. Thus, among other information and features, the system contains information about the addresses of each of the reception and delivery centres/printing facilities associated with the system and the addresses of each of the user interface posts associated with the system.

According to the embodiment shown in FIG. 5, a kiosk 45, which could be a booth or suitable enclosure for instance in the reception area of a hotel or convention centre, at a suitable location in a museum or other site of interest etc., comprises the user interface post 10 and an additional camera 44 located adjacent the interface post but within the area of the kiosk. The interface post furthermore communicates with a local data storage means indicated by reference numeral 46 and comprising a local database 47 for storing for instance a library of pictures 48 to be included on the electronic version of the mail piece. Furthermore, text 49, various kinds of commercials 50 and definitions of types of delivery and layout of mail pieces etc. 51 can be incorporated in the local storage means.

The user interface post 10 communicates with the external world via a local server 6 providing access to the Internet 5 through a chosen Internet provider.

As already described in connection with FIGS. 2 and 3, the interface post itself comprises a number of features, in FIG. 5 exemplified by the blocks 36 (single- or dual side scanner) 37 (CD-ROM reader), magnetic card or chip card reader 38, a keyboard 39 either as a traditional keyboard or in the form of a suitable layout of a touch screen 40, a Bluetooth pen 41 with corresponding receiver for direct handwriting on the scanned-in version of a mail piece and a memory card reader 43. According to this embodiment there is furthermore provided means for indicating the location on the image of the post card where text is to be applied. Such means may comprise a computer mouse or the display screen may also be a touch screen 42 enabling direct tactile indication of for instance the address field 33 of the post card as shown in FIG. 3 above. It is understood that the number of features contained in the interface post is not limited to those described in the present description but that a person skilled in the art could conceive other features relevant for attaining the objects of the invention and that such additional features would naturally fall within the scope of the invention as defined by the appended patent claims. Thus, in stead of using a Bluetooth pen for writing on the image 17 of the post card, a writing board could be provided adjacent the display screen or an ordinary pen or pencil could be used to write on a suitable touch screen.

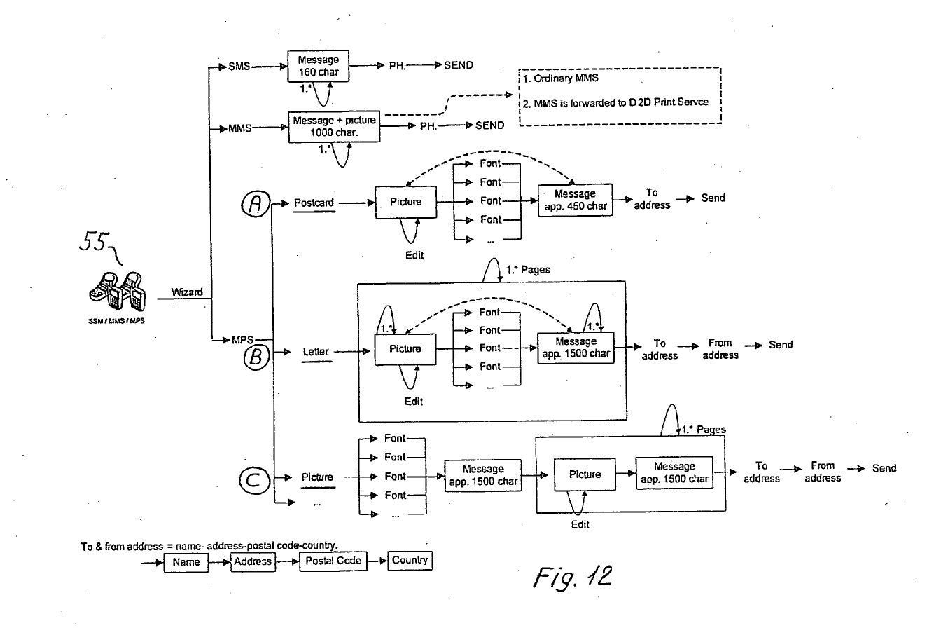

A picture on the mail piece may be composed of several pictures digitally combined or superimposed on each other. Thus, the finished picture may comprise several “layers” of partial images superposed on each other. The creation of the final picture to be transmitted through the system according to the invention may be aided by means of suitable guide or wizard functions, for instance of the kind described in connection with FIG. 12.

Referring to FIG. 6 there is shown the receiving side of the system according to the invention in a specific embodiment hereof. The receiving side of the system shown in FIG. 6 corresponds to the area 4 shown in FIG. 1, i.e. a geographical region which is provided with a regional post office from which electronic versions of mail pieces are distributed to a number of local post offices situated within this area and from which local post offices mail pieces are finally distributed to the addressees. A regional post office 4 at a particular geographical location is provided with a network server 12 in communication with the Internet 5 for instance via a chosen Internet provided. The data are then routed to the local print server 7 possibly via a suitable communication network, for instance a dedicated regional network 52, although any suitable communication network, including the Internet could in principle be used. Data are communicated from the network server 12 to print servers 7 situated at each of the post offices within the region and at each of these post offices a hard copy of the original mail piece is printed on appropriately adapted printing means, which in case of post card reception preferably should provide for dual side printing of the post card on a printing medium preferably resembling that of a typical post card, whereby a hard copy of the same appearance as a post card can be obtained. Furthermore, in order to deal with cases where the data received at the receiving centre also contain additional sound samples, still pictures, video sequences etc., means such as a CD burner 13 must be provided at the reception centre.

The printed post card is according to the invention provided with either a local stamp or a specially designed “stamp” or digital post mark or label for instance bearing the mark “XXXX”, the latter indicating that the system according to the invention has been used in order to effect the delivery of the post card from the first to the second geographical location. Alternatively, the electronic version can already at the user interface post at the first geographical location be provided with a picture of a stamp included in the electronic version of the post card. Finally, the receiving centre provides the post card with the date of reception of the post card, which due to the electronic transmission will equal the date of sending of the post card from the remote location. After finishing the hard copy of the post card this can eventually be delivered to the addressee by ordinary mail service. For this purpose, the reception and delivery centre/printing facility may furthermore be provided with an enveloping device.

An exemplary embodiment of the system according to the invention will now be described in even more detail with reference to FIGS. 7 through 11. It should be noted, however, that even though the different functional units (servers, applications etc.) in FIG. 7 are shown located at specific locations relative to one another and correspond with each other via specifically indicated transmission networks (wide area networks, WAN; local area network, LAN etc.), functional units or parts of functional units may in a real set-up be distributed differently, without the corresponding system departing from the invention as defined by the appended claims.

The system shown in FIG. 7 corresponds in principle to the one shown in FIG. 1, which has been described previously.

The system basically comprises a number of input means, or “clients” 55, 56, 57 and 58 allowing a user to create an electronic mail piece. The system furthermore comprises a global data processing/storage and management block 65, a part of the functional units of which may however be allocated to the different input means or “clients” as described below. The last stage of this global block 65 is according to the shown embodiment a print server 69, which transmits the electronic mail piece to a number of reception and distribution centres or printing facilities 72, where actual physical copies/versions of the mail pieces are created for delivery or distribution to the recipient. Data transmission between the various input means 55, 56, 57 and 58 and the global block 65 takes place via a transmission network 59 of any suitable kind, for instance a WAN (wide area network) using suitable network protocols. Also the transmission of the final electronic mail piece from the print server 67 to the reception and delivery centres or printing facilities 72 takes place via a suitable data transmission network 71.

The system basically comprises a number of input means which may be of the kind actually shown and described in connection with FIGS. 7 through 11, where the input means may be termed “clients”, the clients in this example comprising four different digital input means referred to respectively by reference numerals 55: mobile phones for instance provided with MMS (multi-media message service) facilities and/or MPS (multimedia print service) facilities, 56: a stand, for instance as previously described in connection with FIG. 2, 57: a kiosk, i.e. an area or booth etc. provided with various means for facilitating the preparation and transmission of electronic items of the kind described in the present specification and 58: personal computers (stationary or mobile).

Data processing and storage capabilities differ for different kinds of clients. Thus, for clients with limited processing/storage capabilities, for instance the mobile phones 55, some of the total required data processing/storage application will be provided at the client itself and some of the application be provided by a server application 66 communicating with the client 55 via a suitable communication network, such as the WAN 59 shown in FIG. 7 and an interface application, i.e. in the case of the mobile phones 55, the mobile interface application 60. As already touched upon above, the interface application 60 (and the other interface applications 61, 62 and 63 shown in FIG. 7) may be located remotely from the server application 66 and be communicating with the corresponding server application 66 via a communication network, such as indicated by 70 in the figure. The actual kind of network depends of course on the specific set-up/the actual locations of the interface and server applications. Alternatively a part of the interface application may be run on the server application.

Clients with more processing/storage capacity, such as a stand 56 or a personal computer 58 may run the total application and transmit the resulting electronic version of a mail piece directly to the print server 69, thus relieving the global block 65 of some of the necessary work load.

An important functional unit of the system according to the invention is the storage means or database 68. The database 68 manages and controls the whole system and contains all common features of the system, i.e. the features that all clients 55, 56, 57, 58 may use for instance for preparation of a given mail piece. The database may also store finished mail pieces for a specific printing facility 72, for instance if the connection via the communication network 71 to the printing facility is interrupted for a period or if it is beneficial to forward the mail piece to a particular printing facility during certain time intervals, for instance due to lower transmission costs in those intervals. The database 68 is administered by a global manager 70. Some of the clients with more processing and storage power may comprise a smaller, local database (as shown by reference numerals 47 to 51 in FIG. 5), which may also be used for storing a mail piece in case a connection to a printing facility is interrupted or for storing pictures etc. of a local character, i.e. data which are not relevant for the other clients of the system.

All clients must according to the shown embodiment of the invention contact the server application 66 via the corresponding interface application in order to up-date the database 68.

Each of the interface applications 60, 61, 62, 63 facilitates the access of each of the corresponding kinds of clients to the system. The functions necessary for the communication between each particular client and the system may be suitably divided between the clients' own hardware/software or be comprised totally in the particular interface application. Each of the interface applications may also contain filters dedicated to the particular kind of client, and each interface application may furthermore control up-dating of the clients' own database from the global database 68.

The interfaces furthermore communicate with a payment server 67, which facilitates payment for instance by credit card, etc. Different clients may require different forms of payment and this may be controlled and managed through co-operation of the particular interface application and the payment server. The payment server 67 manages and controls all functions necessary for payment of the transactions from a client. However, at least some of the clients may additionally contain means for storing information relating to payments during communication interruptions. For instance the payment server may control the sending of a mail piece by the clients' interface application asking the payment server whether a credit card used for payment of a transaction from the particular client is authorised for payment of a particular amount. The electronic mail piece is processed and sent through the system to the particular printing facility. When the print server receives information from the particular printing facility that the print file is actually being processed by the printing facility, the print server orders the appropriate parts of the global system, for instance the payment server 67, to effect payment for the transaction.

The server application 66 runs all functions, which the individual clients are not to perform themselves. The server application 66 furthermore manages and controls up-dating of the global database 68 in co-operation with the particular interface application and runs all common functions for the processing of incoming mail pieces from the clients. The incoming mail pieces may for instance be postcards, facsimiles (FAX) or letters with envelopes and may contain text messages written by means of a suitable word-processing program. The mail pieces may contain images, both stills and video sequences and even sound files. In this connection it is emphasised that the printing facilities 72 may not only comprise means for printing a document on a suitable material but also means for preparing CD's and DVD's, etc as mentioned previously.

The print server 69 is one of the key features of the system, and it manages and controls all functions for printing the finished mail pieces. The different printing facilities may require different forms of text files, etc. representing the mail pieces, received by that printing facility and the print server may for instance create the finished mail piece in the form of a PDF-file. Any filters necessary for optimising the printing quality attainable by a particular printing facility may also be run on the print server. A given printing facility may comprise a number of printers, printing different kinds of mail pieces. The transfer from the print server to the particular printing facility may take place using FTP (File Transfer Protocol) or POP3 (Post Office Protocol) or other means preferred by the particular printing facility.

The provision of the global database 68 makes it possible as mentioned above temporarily to store electronic versions of mail pieces created through interaction between the particular client (via his corresponding interface application) and the server application in the database 68, and this stored mail piece may be retrieved by the printing facility in case the corresponding print file sent from the print server contains errors. Thus, electronic versions of mail pieces may be kept in the database 68 for a period of for instance 24 hours. All electronic mail pieces are provided by a unique identification (ID) and can be traced if lost anywhere in the transmission path between the client and the printing facility. The number of electronic mail pieces actually sent from clients of the system can be cross-checked with the number of mail pieces actually printed by the printing facilities. Loss of mail pieces may thus be detected.

Any number of printing facilities 72 may be provided in the system according to the invention and any of the printing facilities may comprise several printers and additional means for preparing CD's, DVD's, etc., as mentioned above. For instance a given country may be served by a single or a number of printing facilities/reception and delivery centres.

In FIG. 7, the different kinds of communication networks required by the system are indicated by B1 (ref. numeral 59, 71) and B2 (ref. numeral 70). B1 denotes a global network, not necessarily a WAN connection but possibly a LAN connection. Any kind of suitable data transmission network can in fact be used, in principle both wired and wireless and combinations of these. Furthermore, although the different functional blocks (interface application 60, 61, 62, 63, server application 66, payment application 67 and print application 69) are shown in FIG. 7 as separate units, they may in practice be implemented by one unified functional unit implemented on a single server.

According to a specific embodiment of the system according to the invention, at least some of the clients may be provided with printer driver means for setting and controlling different parameters relevant to the actual printing of the mail piece at a printing facility and/or for actually choosing a particular printing facility. Such printer driver means may for instance be provided in clients comprising a personal computer, i.e. a client indicated by 55, 58 in FIG. 7.

The system according to the invention can be controlled and managed centrally as indicated by reference numeral 84 in FIG. 7.

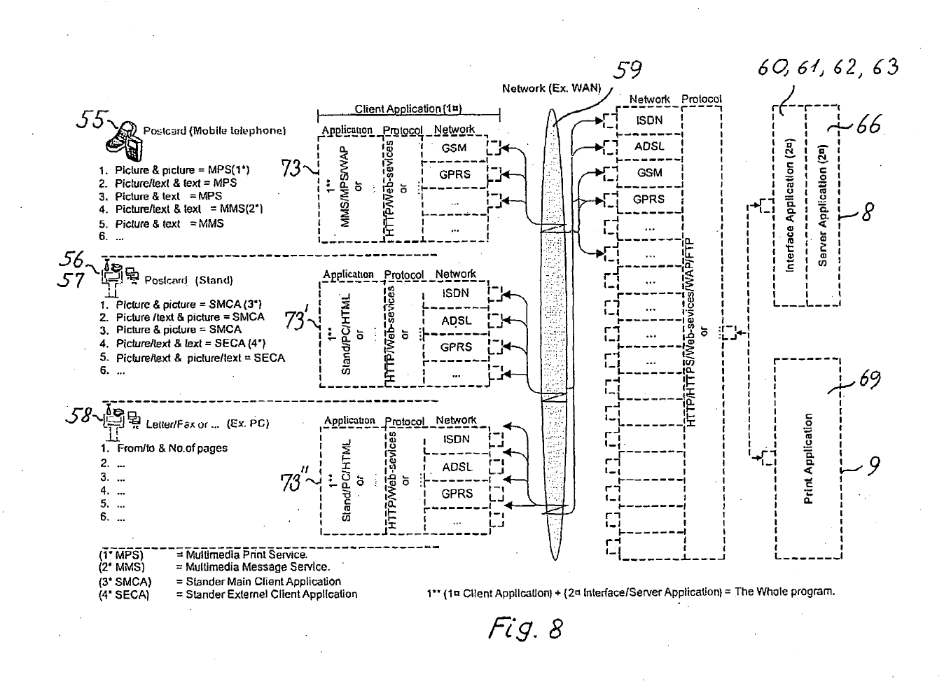

Further details of the system according to the invention shown and described above in connection with FIG. 7 are shown schematically in FIGS. 8 through 11.

Referring to FIG. 8 there is schematically shown the client and interface part of the system substantially corresponding to the clients 55, 56, 57 and 58 with corresponding interface applications 60, 61, 62 and 63 of FIG. 7. Specifically FIG. 8 shows the particular client applications 73, 73′ and 73″ required for the different types of clients with corresponding data file standards such as MMS (multi-media message service), MPS (multimedia print service) etc. and network protocols (GSM, GPRS, ISDN etc.). The client applications communicate with the corresponding interface applications 60, 61, 62 and 63 of the system via the communication network 59 (also shown in FIG. 7). From these interface applications communication is established with the server application 66 and the print server or printer application 69.

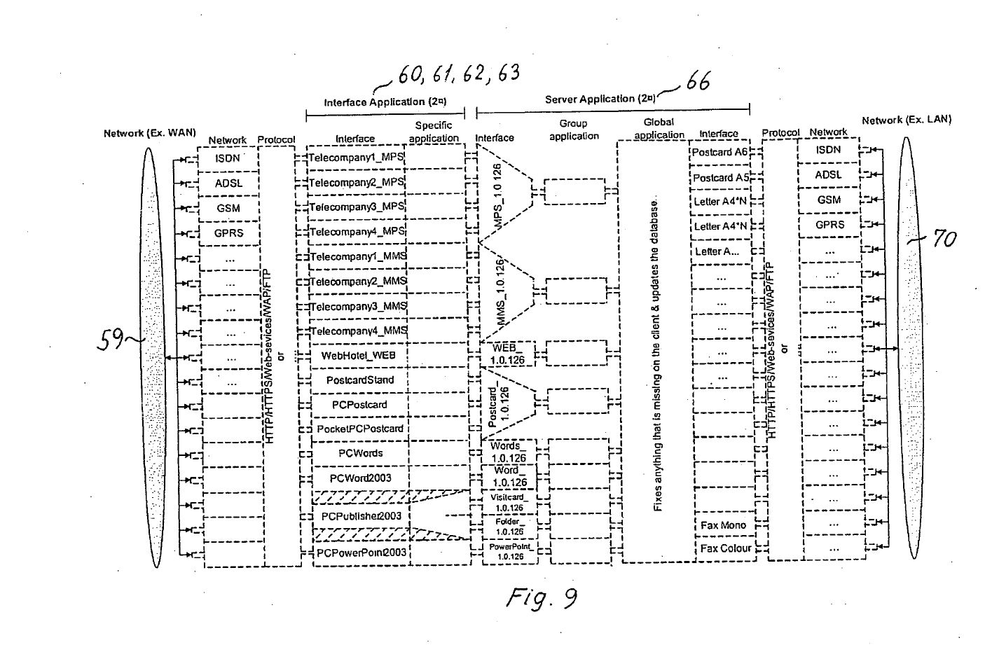

FIG. 9 shows schematically details of the interface applications 60, 61, 62, 63 and the server application 66.

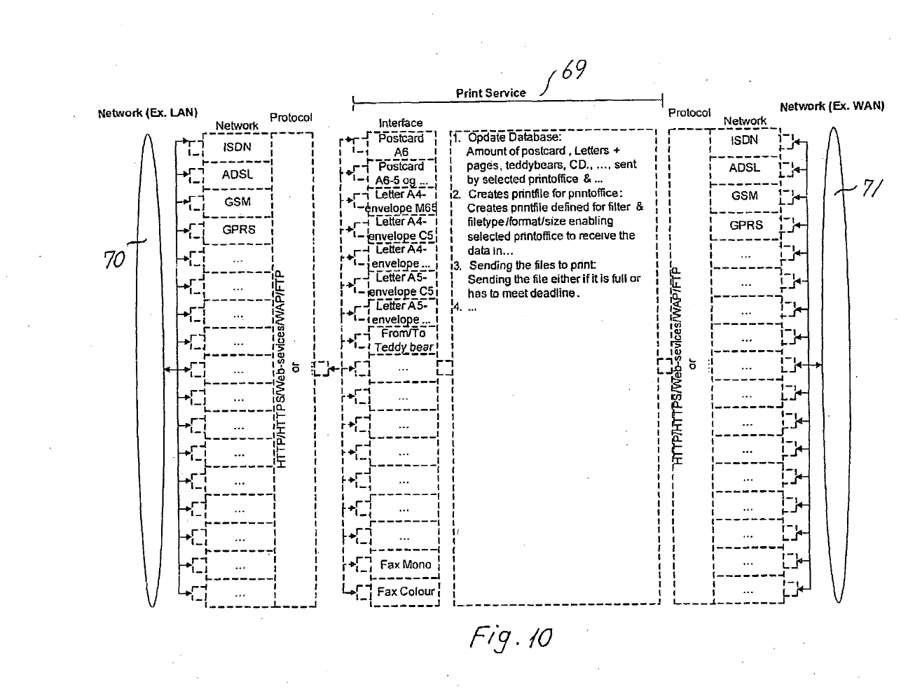

FIG. 10 shows schematically the print server 69 which with the application of the suitable network protocol 74 communicates with and controls the provision of the hard copy of the electronic mail piece at a particular reception and delivery centre/printing facility 72.

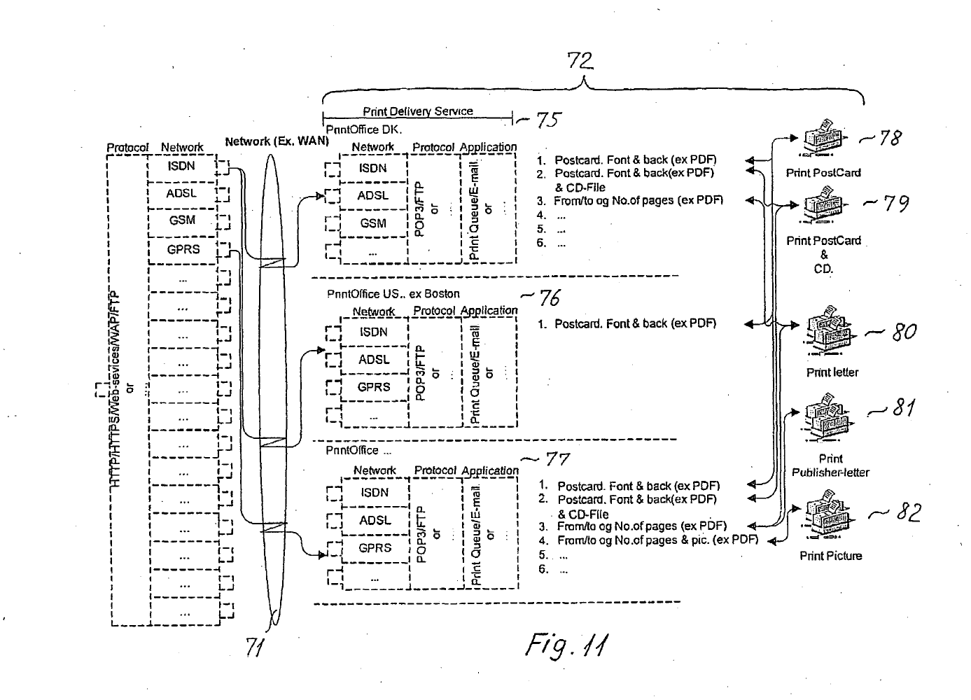

FIG. 11 shows schematically examples of reception and delivery centres/printing facilities 72 located at different geographical locations. Thus 75 indicates a central print office for a larger geographical region (Denmark), from which the printed mail pieces can be distributed to the recipients by normal postal services or alternatively at which office a recipient may pick up his mail piece 76 and 77 indicate regional print offices (76 for the Boston region). These print offices may be provided with a number of different dedicated printing apparatuses, for instance a printer 78 for printing post cards, a printer and additional recording means (a CD burner) 79, printers 80 and 81 specifically designed for printing letters and Publisher letters and printers 82 specifically for printing pictures.

Finally, FIG. 12 shows an auxiliary function (user guide function or wizard) according to the invention to be used for creating electronic mail pieces from a mobile phone 55. The mobile phone 55 may send SMS (Short Message Service) messages or MMS (Multimedia Message Service) messages, the latter comprising both a picture and a text message to a recipient or to the system according to the invention. According to the invention there is furthermore provided a new communication service, MPS (Multimedia Post Service) for the creation of electronic versions of mail pieces. As indicated in FIG. 12, postcards, letters, pictures without text messages, etc. may be sent via MPS. If the “postcard” option is chosen by the user (A in FIG. 12), a picture is provided (for instance downloaded from the global storage means of the invention via the Internet or taken in-situ by a built-in camera in the mobile phone) and a text message (in this embodiment limited to a total of 450 characters) is added. The picture might be edited on the mobile phone. A particular font of the characters to be used in the text message is furthermore chosen. Finally a To-address of the recipient is added and the total electronic postcard is afterwards sent to the global system of the invention. If the “letter” option is chosen by the user (B in FIG. 12), the resulting letter may be composed from several pictures, which might be edited. A character font is chosen for the text message, which in this case may comprise up to 1500 characters. Any number of pages comprising pictures and/or text messages may be used to form the letter. Finally, a To-address and a From-address are added to the electronic letter and this is sent to the global system of the invention.

A further option (C), a mail piece comprising several pictures each provided with individual texts may be provided. Initially a suitable font is chosen and an overall text message consisting for instance of a maximum of 1500 characters is written. Any number of pictures may then be added to the preceding text message, some of these pictures for instance taken by means of a camera provided in the mobile phone or anywhere else and some of which are downloaded from the global database 66, and the individual pictures provided with dedicated text messages/picture captions. As in the above options, the resulting electronic mail piece will be provided with a To-address and a From-address prior to sending to the global system of the invention.

The To- and From addresses might comprise the name, address and number, postal number (zip code etc.) and country.

It is understood that further functions which may aid a user of a mobile communication device in forming an electronic mail piece may be incorporated into the auxiliary function (wizard) of the invention.

1. A method for delivery of mail pieces at an addressee comprising the following steps:
(a) at a first location creating an electronic version of an actually existing physical mail piece or creating a new mail piece;
(b) provision of the address of a reception and delivery centre at a second location to which centre said electronic version of the mail piece is to be sent;
(c) transmission of said electronic version and said address via a transmission path to said reception and delivery centre;
(d) the creation of a hard copy of the electronic version of the mail piece at said reception and delivery centre;
(e) delivery of said hard copy from the reception and delivery centre to the addressee either at the mailing address of the addressee or a pick-up address of the addressee or by picking up of the hard copy at the reception and delivery centre itself.

2. A method according to claim 1, characterized in that said creation of an electronic version of a mail piece is based on a physical mail piece.

3. A method according to claim 2, characterized in that said creation of an electronic version of a mail piece comprises the scanning of a physical mail piece in a 2-dimensional or a 3-dimensional presentation, thereby creating an electronic image of the physical mail piece.

4. A method according to claim 2, characterized in that said creation of an electronic version of a mail piece comprises recording an electronic image of a physical mail piece or other physical entity by photographic means such as a digital camera, either as a 2-dimensional representation or as a 3-dimensional representation.

5. A method according to claim 2, characterized in that said physical mail piece is a post card.

6. A method according to claim 5, characterized in that said physical mail piece is provided with a text message.

7. A method according to claim 2, characterized in that said mail piece is a letter.

8. A method according to claim 3, characterized in that the electronic image of the mail piece is provided with a text message and/or the address of the addressee by means of a user interface provided at said first location.

9. A method according to claim 8, characterized in that said interface is an instrument that can in any way be used for writing.

10. A method according to claim 9, characterized in that said user interface is an electronic keyboard.

11. A method according to claim 9, characterized in that said user interface is a Bluetooth/USB pen.

12. A method according to claim 1, characterized in that said creation of a hard copy of the electronic version of the mail piece is attained by means of a printing apparatus that prints on a printing medium of predetermined physical characteristics.

13. A method according to claim 12, characterized in that said physical characteristics are chosen such that said hard copy attains a predetermined physical appearance.

14. A method according to claim 12, characterized in that said printing apparatus is adapted for printing of both sides of said printing medium.

15. A method according to claim 1, characterized in that the electronic version of the mail piece is furthermore provided with the mail address of the addressee.

16. A method according to claim 1, characterized in that the electronic version of the mail piece furthermore contains digitised video- or audio sequences and that the reception centres are provided with means for making a hard copy of these sequences for delivery to the addressee together with the hard copy of the mail piece.

17. A method according to claim 1, characterized in that said transmission path comprises the Internet.

18. A method according to claim 1, characterized in that said transmission path comprises one or more global centres comprising at least one of the features functions, applications and storage means for control and supervision of the transmission of electronic versions of mail pieces through the transmission path, for storage of finished electronic versions of mail pieces or items to be used for the creation of such mail pieces and for controlling the choice of actual reception and delivery centres/printing facilities where hard copies of the electronic version of the mail piece are to be generated and pertinent parameters controlling said provision of hard copies at a given reception and delivery centre/printing facility.

19. A method according to claim 1 providing for the possibility to create and print both 2-dimensional and 3-dimensional images for use in said mail pieces.

20. A system for delivery of mail pieces at a customer comprising
(a) means for creating an electronic version of a mail piece comprising means for providing information about the appearance (pictures, text fields etc.) of a mail piece and means for loading at least one of the features mailing address of an addressee, the address of a reception and delivery centre/printing facility, or an address where said addressee can pick up a hard copy of the electronic version of a mail piece, into the system;
(b) means for transmission of said electronic version and said addresses to a transmission network;
(c) means for downloading of said electronic version from said transmission network and provision hereof to one or more reception and delivery centres/printing facilities; and
(d) means for providing a hard copy of the electronic version of the mail piece at least one of said reception and delivery centre for subsequent delivery to or pick up by the addressee.

21. A system according to claim 20 comprising one or more global centres comprising at least one of the features of functions, applications and storage means for control and supervision of the transmission of electronic versions of mail pieces through the transmission path from said means for creating an electronic version of a mail piece to said reception and delivery centre/printing facility, for storage of finished electronic versions of mail pieces or items to be used for the creation of such mail pieces and for controlling the choice of actual reception and delivery centres/printing facilities where hard copies of the electronic version of the mail piece are to be generated and pertinent parameters controlling said provision of hard copies at a given reception and delivery centre/printing facility.

22. A system according to claim 20, characterized in that the system furthermore comprises a global interface post server for storing global information for instance comprising pictures, text, commercials etc., which can be utilised by all users of the system and a global control and supervision system for controlling transmission of data throughout the system.

23. A system for providing hard copies of electronic mail pieces at a reception and delivery centre or printing facility for subsequent delivery to an addressee or pick up by the addressee, the system comprising:
(a) one or more clients for creating an electronic version of an actually existing physical mail piece or for creating a new mail piece;
(b) interface applications for communication with said clients;
(c) one or more server applications communicating with said interface applications;
(d) one or more print servers for providing data files representing said electronic mail pieces to said reception and delivery centres/printing facilities and managing and controlling printing operations etc. at these centres/facilities;
(e) one or more global storage means/databases communicating with said server applications and said print server(s).

24. A system according to claim 23, where said clients comprise mobile phones, stands/posts, kiosks, telefax machines and/or personal computers.

25. A system according to claim 23, furthermore comprising a payment server for management and control of payment for transactions carried out by means of the system.

26. A system according to claim 23, where said storage means/database is used for storing electronic representations of images, texts, etc., where these representations may optionally be used by all clients of the system or by chosen clients of the system.

27. A system according to claim 23, where said storage means/database is used for temporarily storing electronic versions of mail pieces prior to their provision from said print server to said reception and delivery centres/printing facilities.

28. A system according to claim 23, where the application which can be run on said server application is either run on a specific client or shared between the server application and a given client.

29. A user interface post for creating an electronic version of a physical mail piece such as a post card comprising means for scanning or taking a photograph of said physical mail piece, means for modifying the appearance of said scanned version of the mail piece, means for displaying the scanned or photographed version and the modified version hereof and means for outputting the modified version of the mail piece for transmission to one or more remote locations.

30. A user interface post according to claim 29, characterized in that said scanning means is a dual scanner enabling simultaneous scanning of both sides of a mail piece.

31. A user interface post according to claim 29, characterized in that the post being furthermore provided with a display screen for displaying the scanned version both with and without said modifications.

32. A user interface post according to claim 29, characterized in that the means for modifying the appearance of the scanned mail piece comprises a keyboard and/or a Bluetooth pen.

33. A user interface post according to claim 29, characterized in that it comprises printer means for printing a hard copy of the modified mail piece.

34. A user interface post according to claim 29, characterized in that it comprises payment means for payment for the transaction at the interface post.

35. A user interface post according to claim 29, characterized in that it comprises means for reading a PDF-417 bar code attached to said physical mail piece.

36. A kiosk comprising a user interface post according to claim 29.

37. A kiosk according to claim 36, characterized in that it is furthermore provided with audio/visual means for further modifying the appearance and/or information content of the electronic version of the mail piece.

38. A kiosk according to claim 37, characterized in that said audio/visual means comprises one or more video cameras and/or microphones.

39. A reception and delivery centre/printing facility for receiving an electronic version of a mail piece and based on this creating a hard copy for delivery at an addressee, the mailing address of whom is received together with the electronic version of the mail piece.

40. A reception and delivery centre/printing facility according to claim 39, characterized in that said hard copy is attained by means of a printer.

41. A reception and delivery centre/printing facility according to claim 40, characterized in that said printer is adapted for printing on both sides of a suitable printing medium.

42. A reception and delivery centre/printing facility according to claim 39, characterized in that it furthermore comprises means for storing further information received together with the electronic version of a mail piece on a storage medium such as a CD or DVD, whereby said further information can be delivered to the addressee together with the hard copy of the electronic mail piece.

43. A reception and delivery centre/printing facility according to claim 39, characterized in that the centre/printing facility provides information to one or more of said global centers or to the input means/clients relating to parameters required by the particular center/printing facility.

44. A reception and delivery centre/printing facility according to claim 39 comprising means for providing the hard copy of the mail piece with an envelope.
